(19) United States
(12) Patent Application Publication
(10) Pub. No.: US 2026/0250077 A1
(43) Pub. Date: Aug. 27, 2026

(54) DEVICE FOR MOUNTING A ROLLER ASSEMBLY TO A CONVEYOR FRAME

(71) Applicant: Laitram, L.L.C., Harahan, LA (US)

(72) Inventors: Mohan Jake A., Grand Rapids, MI (US); Ryan Hale, New Orleans, LA (US); Paul A. Marsman, Wyoming, MI (US); Kevin W. Guernsey, Destin, FL (US); Jonathan J. Bishop, Amite, LA (US); David Aaron vanSchalkwijk, Metairie, LA (US)

(21) Appl. No.: 19/160,145

(22) PCT Filed: Feb. 26, 2024
(86) PCT No.: PCT/US2024/017227

§ 371 Date: Aug. 27, 2025

Related U.S. Application Data
(60) Provisional application No. 63/450,146, filed on Mar. 6, 2023.

(51) Int. Cl. B65G 39/12; B65G 23/04

(52) U.S. Cl. CPC B65G 39/12; B65G 23/04

(57) ABSTRACT

A mounting device for mounting components to a conveyor frame includes an outer portion that sits against a side wall of the conveyor frame and an inner portion that extends through an opening in the side wall and includes a saddle for rotatably seating a shaft. The mounting device includes a mounting channel that receives an edge of the opening to mount the mounting device in an operative position.

### RELATED APPLICATIONS

This application claims priority to U.S. Provisional Patent Application Ser. No. 63/450,146, filed Mar. 6, 2023 and entitled “Device for Mounting a Roller Assembly to a Conveyor Frame” the contents of which are herein incorporated by reference.

### FIELD OF THE INVENTION

The present invention relates to power-driven conveyors. More particularly, the invention relates a saddle for mounting components, such as rollers, side guards and-or belt-supporting shoes, to a conveyor frame.

### BACKGROUND OF THE INVENTION

Conveyor belts are used in many industries to convey products from first location to a second location. Conveyor belts generally form an endless belt loop that is trained around drive and idler sprockets or rollers at each end of a conveying path. Articles are conveyed atop the conveyor belt are supported along an upper carryway. The conveyor belt returns along a lower returnway. To minimize the maximum sag of the conveyor belt in the returnway, return shoes or rollers are often used. Return rollers typically extend across the width of the conveyor belt at selected positions along the returnway. Rollers may also be used to support a conveyor belt at the infeed end of the endless conveyor belt circuit and-or another location. Mounting rollers, sprockets and other components on a shaft in a conveyor can be difficult and cumbersome. In addition, separate locking components are often required to secure the component in a fixed axial position along the shaft.

### SUMMARY OF THE INVENTION

A shaped mounting device mounts auxiliary conveyor components, such as, but not limited to, an idler roller assembly, to a conveyor frame. The shaped mounting device includes an outer portion configured to sit against an outside surface of a conveyor frame side wall, an inner portion that extends through an opening in the conveyor frame side wall and includes a saddle for rotatably mounting an end of a shaft, and a mounting channel for receiving an edge of the side wall opening to mount the shaped mounting device to the conveyor frame side wall.

According to a first aspect, a mounting device for mounting a shaft to a conveyor frame is provided. The conveyor frame has an opening in a side wall, the opening having an upper portion and a lower portion having a smaller width than the upper portion. The mounting device comprises an outer portion configured to seat against an outside surface of the side wall and having a width greater than the opening upper portion, an inner portion having a width that is smaller than the opening upper portion and including an inward facing saddle for the shaft and a mounting channel formed between the inner portion and the outer portion for receiving a bottom edge of the opening.

According to another aspect, an assembly for a conveyor comprises a first mounting device, a second mounting device and a shaft mounted to and between the first and second mounting devices. The first mounting device is configured to be mounted in a first opening in a first side wall and includes an outer portion abutting an outer surface of the first side wall and a first saddle extending inwards from an inner surface of the first side wall. The second mounting device is configured to be mounted in a second opening in a second side wall opposing the first side wall. The second mounting device includes an outer portion abutting an outer surface of the second side wall and a second saddle extending inwards from an inner surface of the second side wall. The shaft has at least one conveyor component mounted thereon and includes a first end mounted in the first saddle and a second end mounted in the second saddle.

According to another aspect, a conveyor assembly comprises a first frame side wall, a first mounting device mounted to the first frame side wall, a second frame side wall, a second mounting device mounted to the second frame side wall and a shaft rotatable mounted to and between the first and second mounting devices. The shaft has at least one conveyor component mounted thereon. The first frame side wall has a first opening with a wide upper portion and a narrower lower portion. The first mounting device is mounted in the first opening and includes an outer portion abutting an outer surface of the first frame side wall and a first saddle extending inwards from an inner surface of the first frame side wall. The second frame side wall has a second opening opposite the first opening. The second opening includes a wide upper portion and a narrower lower portion. The second mounting device is mounted in the second opening and includes an outer portion abutting an outer surface of the second frame side wall and a second saddle extending inwards from an inner surface of the second frame side wall. The shaft includes a first end rotatably mounted in the first saddle and a second end rotatably mounted in the second saddle.

### BRIEF DESCRIPTION OF THE FIGURES

FIG. 1 is an isometric view of a returnway roller assembly in a conveyor that is mounted to a conveyor frame using a pair of mounting devices according to an embodiment of the invention;

FIG. 2 is a detailed outside view of the returnway roller assembly and outside of a mounting device of FIG. 1;

FIG. 3 is an isometric view of an edge portion of the returnway roller assembly and mounting device of FIG. 1;

FIG. 4 is an inner view of the edge portion of FIG. 3;

FIG. 5 is a front view of the edge portion of FIG. 3;

FIG. 6 is an isometric view of a conveyor frame side wall including an opening for receiving a mounting device according to an embodiment;

FIG. 7 shows a conveyor frame side wall with a mounting opening extending to the bottom edge of the side wall according to another embodiment;

FIG. 8 is an isometric view of a mounting device for a conveyor of an embodiment;

FIG. 9 is an inner view of the mounting device of FIG. 8;

FIG. 10 is a side view of the mounting device of FIG. 8;

FIG. 11 is an outer view of the mounting device of FIG. 8;

FIG. 12 is an inner view of the conveyor frame side wall of FIG. 6 with the mounting device of FIG. 8 mounted thereto;

FIG. 13 is a cross-sectional view of the edge portion of the roller assembly and mounting device of FIG. 3;

FIG. 14 is another cross-sectional view of the edge portion of FIG. 13;

FIGS. 15A-15C show the process of mounting the mounting device of FIG. 8 in the conveyor frame side wall of FIG. 6;

FIG. 16 is an isometric view of a mounting device and edge portion of a roller assembly according to another embodiment;

FIG. 17 is an inner view of the mounting device and outer portion of FIG. 16;

FIG. 18 is an isometric view of the outer side of the mounting device of FIG. 16;

FIG. 19 is an isometric view of the inner side of the mounting device of FIG. 18;

FIG. 20 is an outer view of the assembly of FIG. 16 in a cleaning position;

FIG. 21 in an inner view of the assembly of FIG. 16 in the cleaning position;

FIG. 22 is an outer view of the assembly of FIG. 16 during removal or insertion of the mounting device;

FIG. 23 is an isometric view of a mounting device according to another embodiment;

FIG. 24 is an isometric view of a mounting device including a flexible anchor according to another embodiment;

FIG. 25 is an isometric view of a roller assembly mounted to conveyor frame side walls using the mounting device of FIG. 24;

FIG. 26 is an isometric view of a mounting device according to another embodiment;

FIG. 27 is an isometric view of a mounting device according to another embodiment;

FIG. 28 is an isometric view of a mounting device including a compressible inner portion according to another embodiment;

FIG. 29 is a front view of the mounting device of FIG. 28;

FIG. 30 is an isometric view of a mounting device including upper projections according to another embodiment;

FIG. 31 is a front view of the mounting device of FIG. 30;

FIG. 32 is an isometric view of a mounting device mounted in a conveyor frame side wall including a locking clip according to another embodiment.

FIG. 33 is an isometric view of the mounting device of FIG. 32;

FIG. 34 is an inner view of a mounting device according to another embodiment;

FIG. 35 is an outer view of the mounting device of FIG. 34;

FIG. 36 is an outer view of a mounting device including a conveyor belt guard according to another embodiment;

FIG. 37 is an inner view of the mounting device of FIG. 36.

### DETAILED DESCRIPTION OF THE INVENTION

The present invention provides a mounting device for mounting a roller assembly or other conveyor component to a conveyor frame. The present invention will be described below relative to an illustrative embodiment. Those skilled in the art will appreciate that the present invention may be implemented in a number of different applications and embodiments and is not specifically limited in its application to the particular embodiments depicted herein.

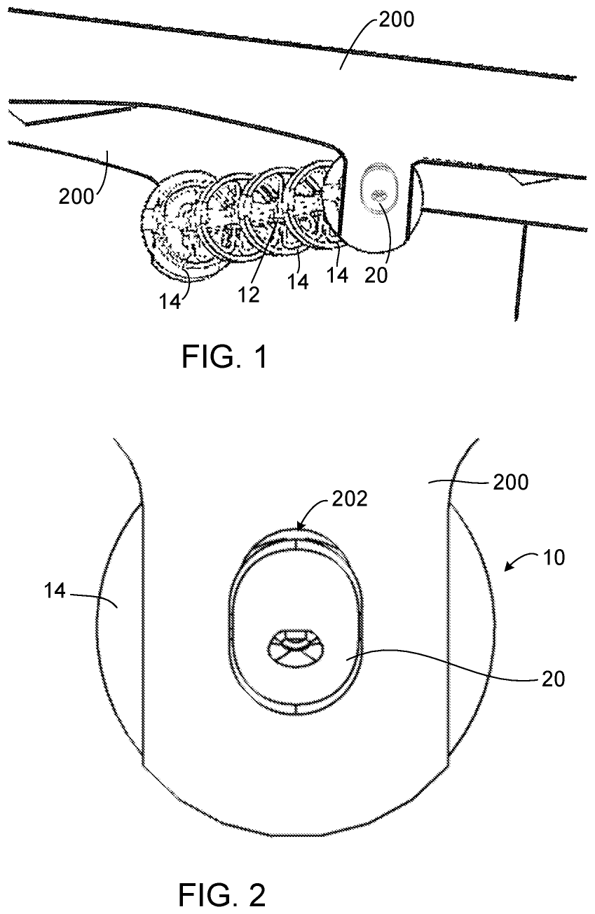

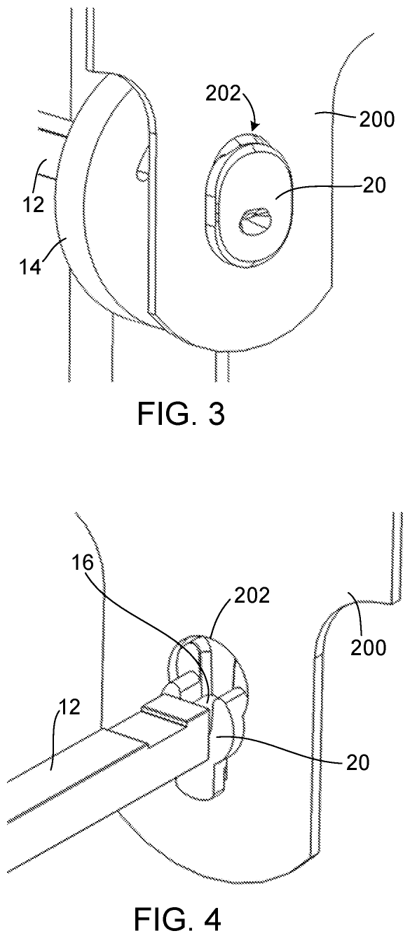

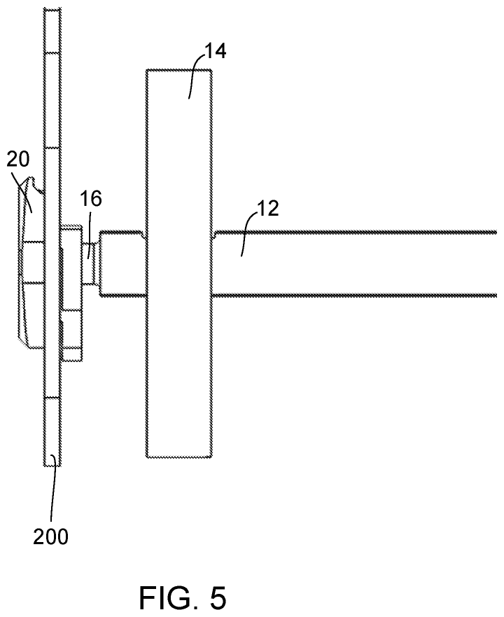

Referring to FIGS. 1-5, a conveyor roller assembly 10 comprises a series of conveyor rollers 14 mounted on a mounting shaft 12 extending between two side walls 200 of a conveyor frame. The illustrative series of conveyor rollers 14 are evenly spaced along the axial length of the mounting shaft, but the invention is not so limited, and any number conveyor rollers 14 can be mounted in any suitable location and-or patterns. In one embodiment, the conveyor rollers are returnway rollers, mounted in the returnway of a conveyor for guiding and-or supporting the conveyor belt as it travels from the outfeed, discharge end, back to the infeed of the conveyor. As the conveyor belt moves over the outer rims of the conveyor rollers 14, it may spin the conveyor roller assembly 10. The illustrative rollers 14 are fixedly mounted to the mounting shaft 12 during operation, with end journals 16 inserted in mounting devices 20 mounted to the side walls 200 to allow spinning of the whole assembly 10 in unison. The illustrative mounting devices 20 are static plastic components to facilitate rotation of the shaft, but other materials may be used. One skilled in the art will recognize that the illustrative conveyor roller assembly may be implemented in any suitable location in a conveyor, such as the infeed or other suitable location where support of a conveyor belt is useful.

The illustrative mounting devices 20 are separate components designed to be mounted to the side walls 200 of the conveyor frame. Each mounting device 20 is configured to be received in a corresponding opening 202 in the corresponding side wall and secured in position to receive an end journal 16. Each mounting device 20 is mounted from outside the side wall, such that a saddle for receiving an end journal extends inwards from the side wall 200, an outer portion abuts an outer surface of the side wall 200 and a mounting channel receives one or more edges of the opening 202 to secure the mounting device 20 in position to mount a shaft or other component.

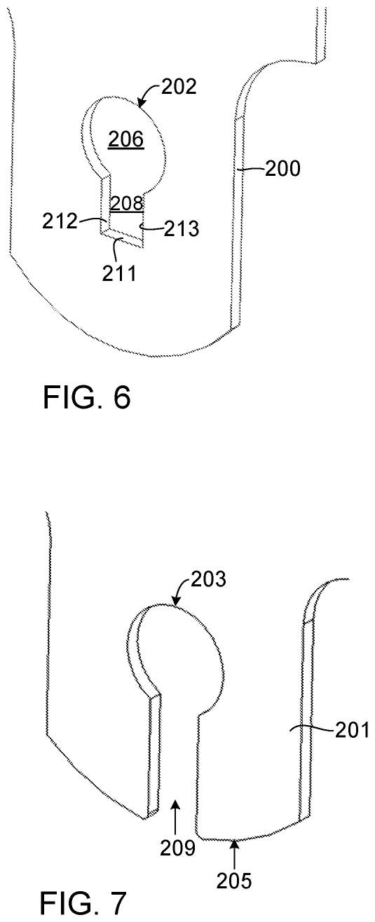

As shown in FIG. 6, the illustrative mounting opening 202 includes an upper portion 206 and a narrower lower portion 208. The illustrative upper portion 206 is circular and the narrower lower portion 208 is rectangular to form a keyhole shape, but the invention is not so limited. The illustrative narrower lower portion 208 includes a bottom edge 211 and side edges 212, 213. The mounting opening 202 can have any suitable size, shape and configuration. For example, in another embodiment shown in FIG. 7, a narrower lower portion 209 of a mounting opening 203 may be open to the bottom edge 205 of a conveyor frame side wall 201.

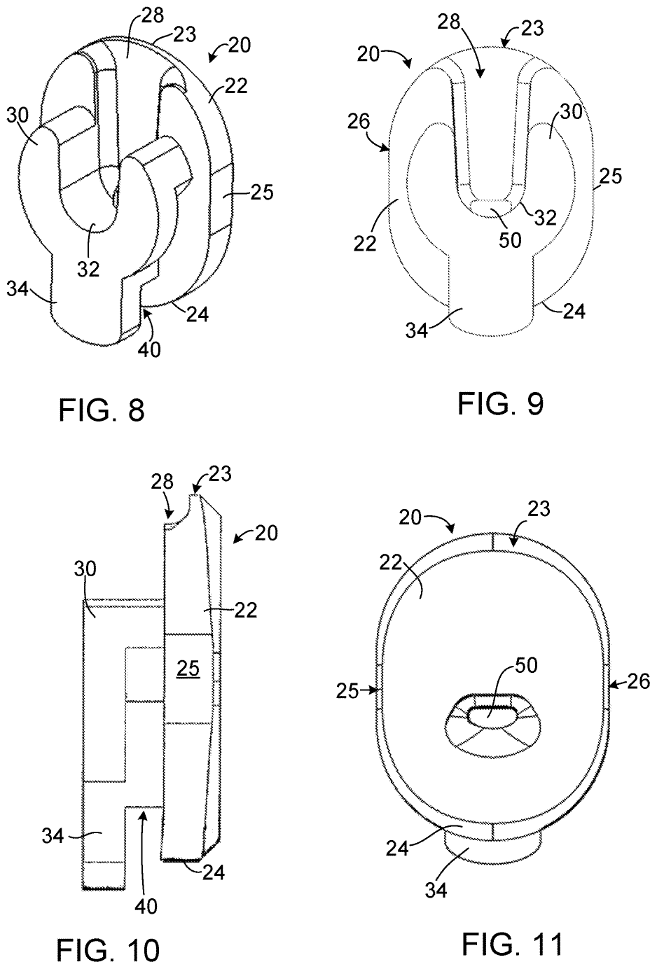

Referring to FIGS. 8-11, an illustrative mounting device 20 comprises a shaped body having an outer portion 22 that is configured to seat against an outside surface of the side wall 200 without being able to pass therethrough. The illustrative outer portion 22 has a substantially obround shape, with curved top and bottom surfaces 23, 24 and flat sides 25, 26, but the invention is not so limited. The outer portion 22 of the mounting device is larger than the upper portion 206 of the frame opening 202 and therefore unable to pass therethrough.

An inner portion 30 of the shaped body is narrower than the upper portion 206 of the frame opening 202 and configured to pass through the upper portion 206 of the opening 202. The inner portion 30 is wider than the lower portion 208 of the opening 202. The inner portion 30 includes an inward facing saddle 32 designed to extend inwards from an inside surface of the side wall 200. The saddle 32 includes a rounded bottom and flat, upwardly extending side walls to allow a shaft journal to rotatably sit therein, but the saddle can have any suitable shape for mounting an end of a shaft. The illustrative saddle 32 is u-shaped, with an open top, but can alternatively have a closed top, and-or an o-shape or any other suitable shape. The illustrative inner portion 30 further includes a stem 34 extending down from the saddle 32 and narrower in width than the saddle 32. The illustrative stem 34 extends below the bottom edge 24 of the outer portion 22, but the invention is not so limited.

The mounting device 20 further includes a mounting channel 40 for securing the mounting device 20 to the side wall 200. The mounting channel 40 is formed in the bottom of the inner portion 30 between the stem 34 and outer portion 22. The illustrative mounting channel 40 extends along the sides of the saddle 32. When mounted, the mounting channel 40 receives the bottom edge 211 of the opening 202 and the side edges 212, 213 of the narrower lower portion 208 to secure the mounting device 20 on the side wall 200. The mounting channel can be formed in any suitable location to position the saddle 32 relative to the side wall 200.

The illustrative mounting device 20 further includes a through hole 50 extending through the outer portion 22 from the saddle 32 to an outside surface of the outer portion 22 for drainage and-or cleaning purposes. The illustrative through hole 50 widens from the saddle 32 to the outside surface of the outer portion 22.

The illustrative mounting device 20 further includes a vertical channel 28 on an inner surface of the outer portion 22 that extends from the top edge 23 to the saddle 32 and effectively extends the saddle 32 into the inner surface of the outer portion 22. The vertical channel allows the end of the shaft to extend through the side wall 200 of the frame. The vertical channel 28 may also facilitate visual confirmation of the placement of the shaft journal, as well as cleaning, if necessary.

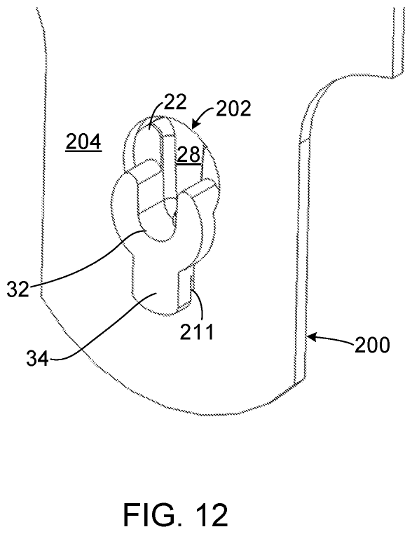

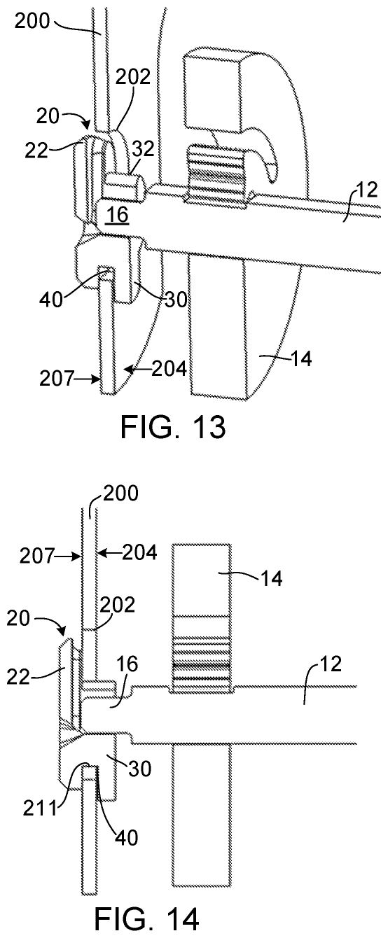

As shown in FIGS. 12-14, when the mounting device 20 is mounted in a mounting opening 202 in a conveyor frame side wall 200, the saddle 32 protrudes from an inner surface 204 of the side wall 200 and the stem 34 extends below the bottom edge 211 of the opening 202. The size, shape and configuration of the outer portion 22 prevents the outer portion 22 from passing through the opening 202. The outer portion 22 rests flat against the outer surface 207 of the side wall 200. The end journal 16 of the shaft 12 rests in the saddle 32 and extends through the opening 202 into the vertical channel 28 of the outer portion 22.

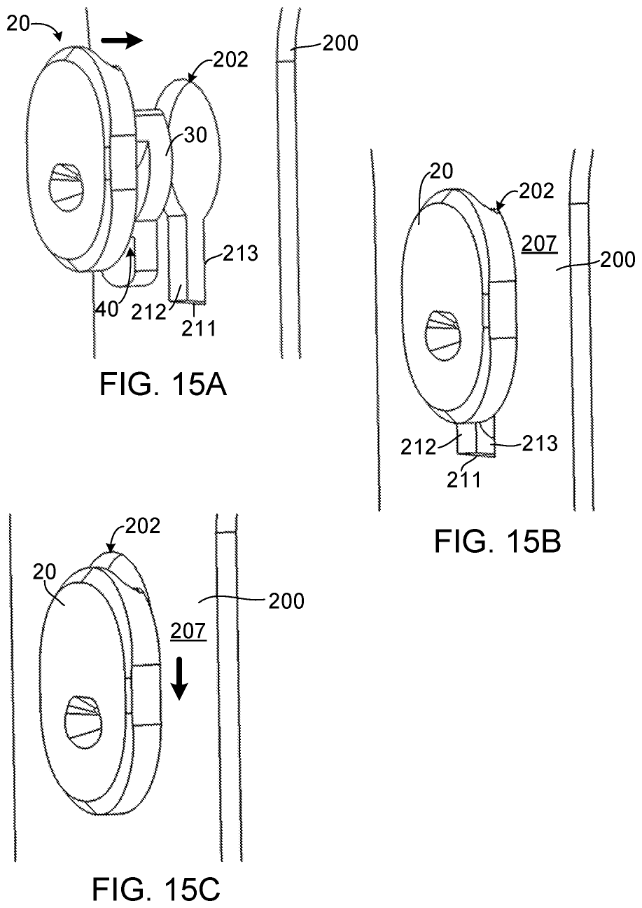

As shown in FIGS. 15A-15C, to mount the mounting device 20 in a conveyor, the mounting device 20 is brought near the opening 202 of a side wall 200, with the inner portion 30 closest to the side wall 200. The illustrative mounting device 20 is configured so that the inner portion 30 can pass through the upper portion of the opening 202 without being angled, but alternatively, the mounting device 20 may be angled or otherwise oriented, to pass the inner portion 30 through the opening 202. FIG. 15B shows the mounting device after passing the inner portion 30 through the opening 202. Then, the mounting device 20 may be dropped or slid down, as shown in FIG. 15C, so that the bottom edge 211 and lower side edges 212, 213 of the opening are received in the mounting channel 40 and the outer portion 22 abuts the outside surface 207 of the side wall 200. The mounting channel 40 and other geometries secure the mounting device 20 in a desired position for mounting a shaft or other component. As described, the mounting device 20 may rotatably mount a shaft, but the invention is not so limited. The mounting device 20 may be removed in a reverse process.

The mounting device 20 may easily release the shaft, if desired. For example, the mounting device 20 may be rotated within the upper portion 206 of the opening 202 to place the open top of the saddle down to release the shaft without fully removing the mounting device 20 from the opening 202. When the mounted device is in the mounted position and holding the end of the shaft, the shaft preferably cannot be removed from the conveyor frame.

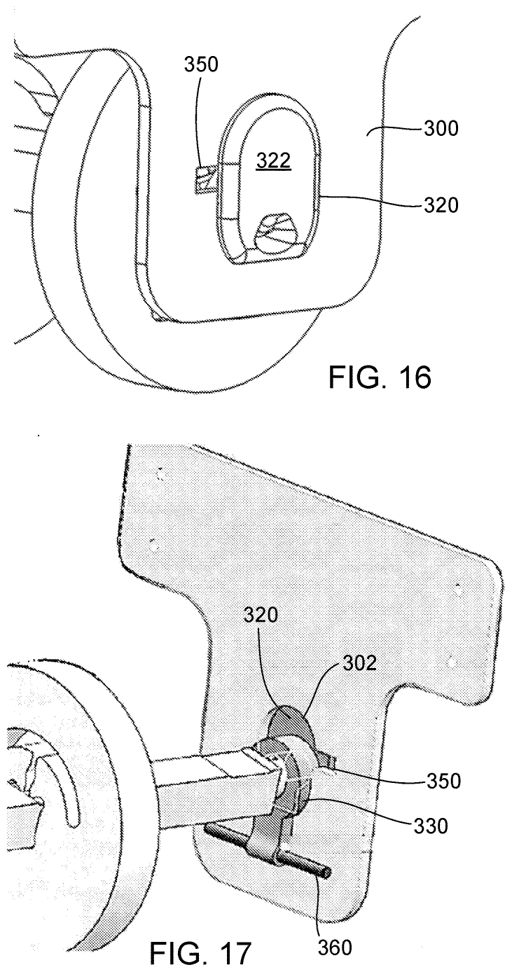

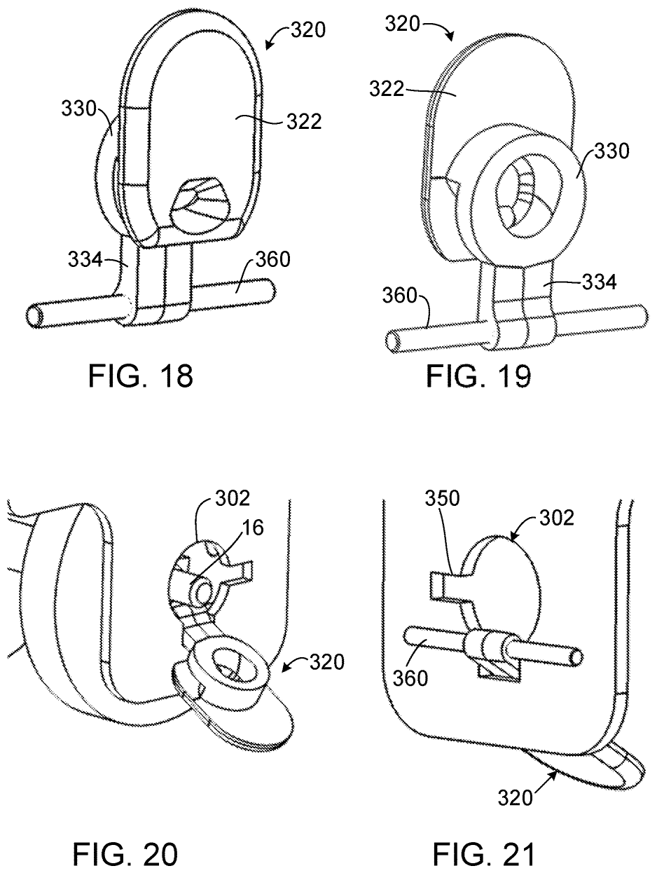

In another embodiment, shown in FIGS. 16-19, a conveyor component mounting device 320 includes an anchor 360 extending perpendicular to and from the bottom of a stem 334 on an inner portion 330 forming a saddle 332 for a shaft. The illustrative outer portion 322 covers the side wall opening 302 and has a flat bottom, but the invention is not so limited. The outer portion 322 is sized and configured to abut the outer surface of the conveyor frame side wall 300 without passing through the opening 302. The illustrative opening 302 includes a larger upper portion, narrower lower portion and an additional slot 350 to allow anchor 360 to pass therethrough. In the embodiment of FIGS. 16-19, the anchor 360 is a round bar, which can be metal or another material to increase strength, extending through an opening in the stem 334 of the inner portion 330. The anchor 360 can be added after insertion of the mounting device 320. In the embodiment of FIGS. 16-19, the inner portion 330 forms a closed saddle for receiving a shaft end, but the invention is not so limited.

As shown in FIGS. 20 and 21, the anchor can allow pivoting of the outer portion 322 and inner portion 330 out of engagement with the shaft end 16 for cleaning or another purpose without full separation of the mounting device 320 from the conveyor frame.

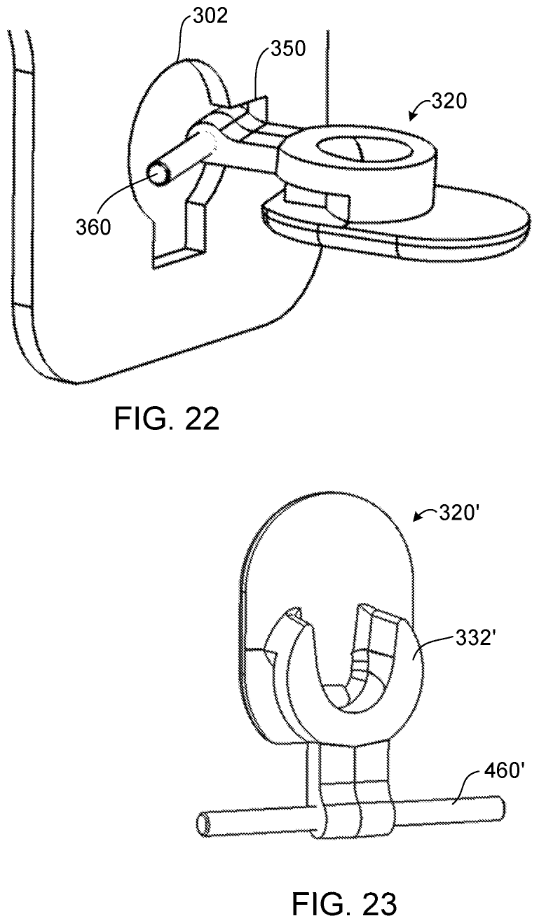

As shown in FIG. 22, the slot 350 in the side wall opening 302 can allow insertion and-or removal of the mounting device 320 by orienting the anchor 360 to pass through the slot 350.

Alternatively, an anchor for a mounting device can be integral with the stem of an inner portion forming a saddle.

In addition, in another embodiment, the saddle 332′ of a mounting device 320′ with an anchor 460′ may be open, as shown in FIG. 23.

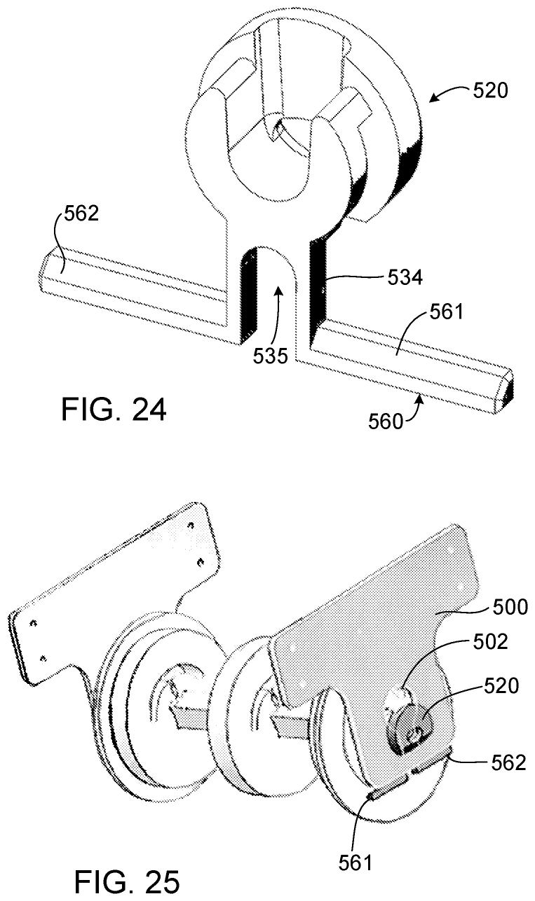

In another embodiment, shown in FIGS. 24-25, an anchor 560 for a mounting device 520 can be compressible. The illustrative stem 534 of the mounting device 520 includes a gap 535 between two perpendicular arms 561, 562 forming the anchor 560. The arms 561, 562 can be pushed together to fit the anchor through an opening 502 in a conveyor frame side wall 500, then expand in a mounted position, as shown in FIG. 25.

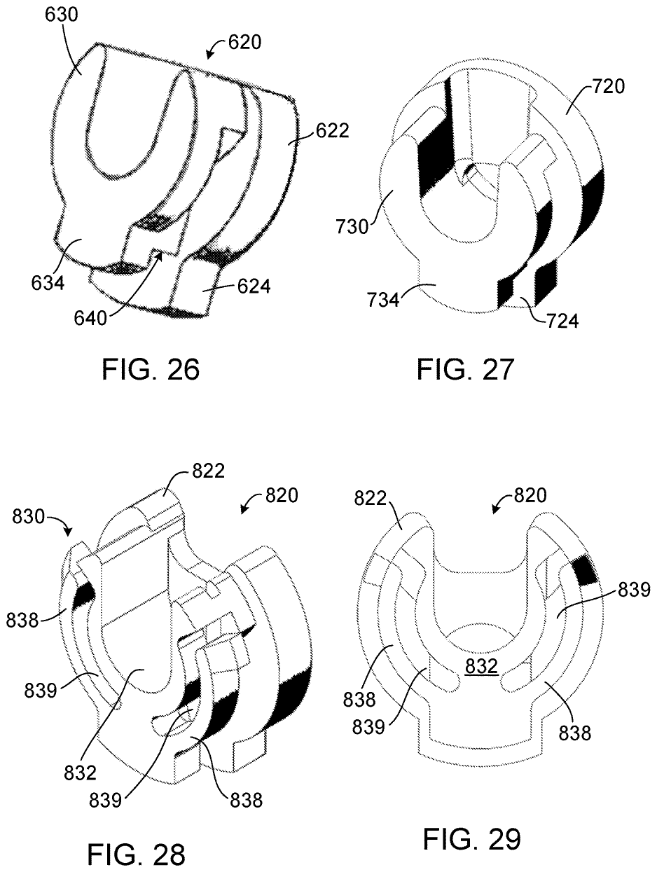

FIG. 26 shows another embodiment of a mounting device 620 suitable for mounting a rotating shaft to a conveyor frame. The mounting device 620 includes an outer portion 622 that is larger than opening in conveyor frame and comprises a solid truncated disc with a stem 624. An inner portion 630 forms a u-shaped saddle with a stem 634 stem shorter than the outer portion stem 624. A mounting channel 640 is formed between the stems 634, 623 and alongside the saddle for mounting the mounting device 620 to a conveyor frame side wall, as described above.

In another embodiment, shown in FIG. 27, a mounting device 720 includes outer portion 722 with a disc shape extending above the inner portion 730. Both the illustrative outer portion 722 and inner portion 730 include stems 724, 734, as described above.

In another embodiment, shown in FIGS. 28 and 29, the inner portion 830 of a mounting device 820 may be compressible to facilitate insertion of the inner portion 830 through a conveyor frame side wall opening. The illustrative inner portion 830, which is smaller than the outer portion 822, which may comprise any suitable size, shape and configuration suitable for interfacing an outer surface of the conveyor frame side wall, includes a u-shaped saddle 832 surrounded by flexible fingers 838. Channels 839 separate the flexible fingers 832 from the saddle 832. The illustrative saddle 832 and fingers 838 include end tabs, but the invention is not so limited. The illustrative end tabs of the fingers 838 do not extend past the periphery of the outer portion 822, as shown in FIG. 29, but the invention is not so limited. The flexible fingers 838 can be compressed against the saddle 832 to reduce the size of the inner portion 830, allowing it to pass through a side wall opening. After insertion, the flexible fingers 838 can spring back to a relaxed position, facilitating positioning and securing of the mounting device 830 to the conveyor frame side wall.

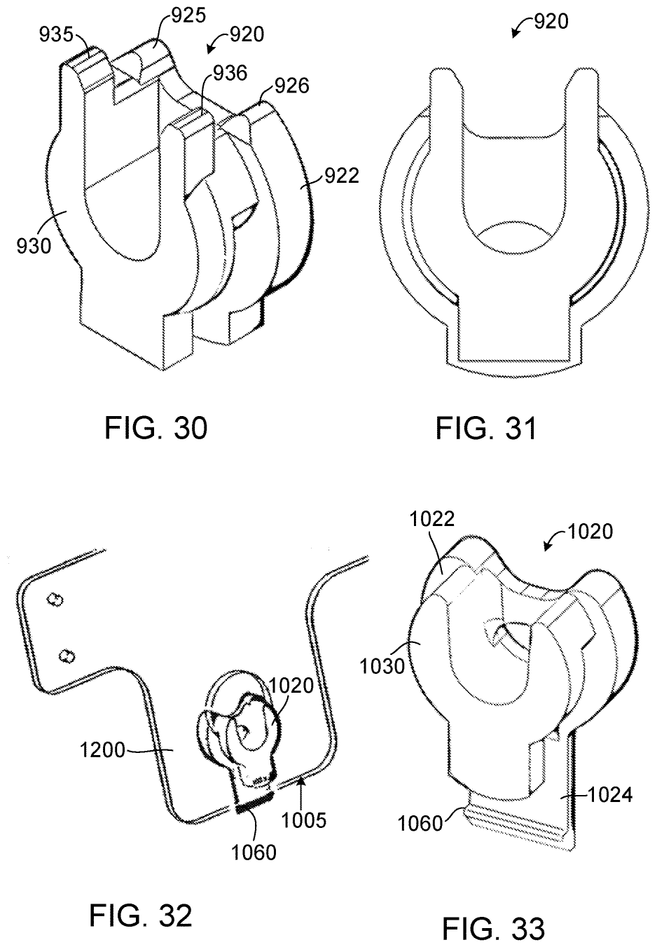

In another embodiment, shown in FIGS. 30-31, a saddle-forming inner portion 930 of a mounting device 920 includes upper projections 935, 936 to facilitate containment of the mounting device. The illustrative outer portion 922 includes shorter projections 925, 926 opposite the inner projection 935, 936 to form a secondary mounting channel therebetween that receives the side wall.

In another embodiment, shown in FIGS. 32 and 33, a mounting device 1020 having a larger outer portion 1022 and a smaller, saddle-forming inner portion 1030 further includes a locking clip 1060 at a bottom of an outer portion stem 1024. The locking clip 1060 is configured to snap onto and lock against a bottom edge portion 1005 of a side wall 1200 in which the mounting device 1020 is mounted, as shown in FIG. 32.

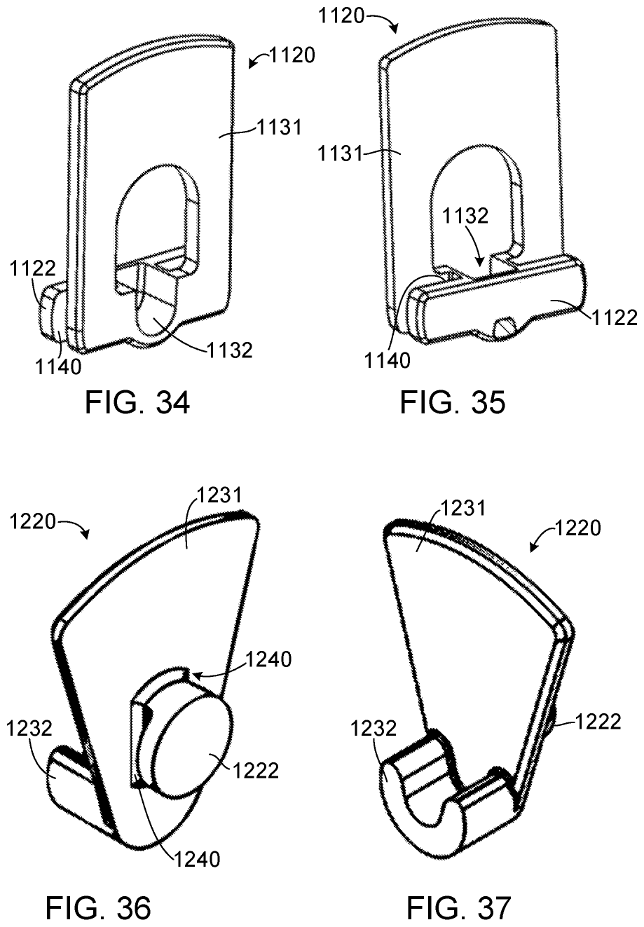

FIGS. 34 and 35 show another embodiment of a mounting device 1120 includes an inner belt-protecting wing 1131 formed around a saddle 1132 formed on an inner portion. An outer portion 1122 is configured to abut an outer surface of a conveyor frame side wall. A mounting channel 1140 between the wing 1131 and outer portion 1122 receives the conveyor frame side wall. The illustrative saddle 1132 extends to the inner surface of the outer portion 1122. The mounting device 1120 may be inserted through a corresponding opening in a conveyor frame side wall in a first orientation, then rotated or otherwise moved to a second orientation to lock the mounting device 1120 to the side wall.

FIGS. 36 and 37 show another embodiment of a mounting device 1220 including a tapering belt-protecting wing 1231. A saddle 1232 extends inwards from the wing 1231 for rotatably receiving an end of a shaft of a conveyor. An outer portion 1222 extends from an outward-facing surface of the wing 1231 and is configured to abut an outer surface of a conveyor frame side wall. A mounting channel 1240 separates the outer portion 1222 from the wing 1231 for receiving an edge of an opening in the side wall to mount the mounting device 1220 to the side wall.

In another embodiment, not shown, the saddle of a mounting device can include a bottom groove to facilitate cleaning.

Other suitable auxiliary conveyor components may be integrated to a conveyor using the illustrative mounting devices, and the invention is not limited to rollers assemblies.

The scope of the claims is not meant to be limited to the details of the described exemplary embodiments.

What is claimed is:

1. A mounting device for mounting a shaft to a conveyor frame having an opening in a side wall, the opening having an upper portion and a lower portion having a smaller width than the upper portion, the mounting device comprising:
an outer portion configured to seat against an outside surface of the side wall and having a width greater than the opening upper portion;
an inner portion having a width that is smaller than the opening upper portion and including an inward facing saddle for the shaft; and
a mounting channel formed between the inner portion and the outer portion for receiving a bottom edge of the opening.

2. The mounting device of claim 1, wherein the outer portion has an obround shape.

3. The mounting device of claim 1, wherein the mounting channel extends along sides of the inner portion for receiving side edges of the opening.

4. The mounting device of claim 1, wherein the inner portion comprises a stem extending down from the saddle.

5. The mounting device of claim 1, further comprising a locking clip for locking the mounting device to a bottom edge of the side wall.

6. The mounting device of claim 4, further comprising an anchor extending laterally from a bottom of the stem.

7. The mounting device of claim 1, wherein the saddle is u-shaped.

8. The mounting device of claim 1, further comprising a through hole in the outer portion that extends from the saddle to an outer surface of the outer portion.

9. The mounting device of claim 1, wherein the outer portion has a flat inner surface with a central vertical channel that intersects the saddle.

10. The mounting device of claim 1, wherein the inner portion is compressible.

11. The mounting device of claim 1, further comprising a wing surrounding the saddle and configured to abut an inner surface of the side wall.

12. An assembly for a conveyor, comprising:
a first mounting device configured to be mounted in a first opening in a first side wall, the first mounting device including an outer portion abutting an outer surface of the first side wall and a first saddle extending inwards from an inner surface of the first side wall;
a second mounting device configured to be mounted in a second opening in a second side wall opposing the first side wall, the second mounting device including an outer portion abutting an outer surface of the second side wall and a second saddle extending inwards from an inner surface of the second side wall; and
a shaft having at least one conveyor component mounted thereon, the shaft including a first end mounted in the first saddle and a second end mounted in the second saddle.

13. The assembly of claim 12, wherein the shaft is rotatably mounted in the first and second saddles.

14. The assembly of claim 12, wherein each mounting device includes a mounting channel formed between the inner portion and the outer portion.

15. A conveyor assembly comprising:
a first frame side wall having a first opening with a wide upper portion and a narrower lower portion;
a second frame side wall having a second opening opposite the first opening, the second opening including a wide upper portion and a narrower lower portion;
a first mounting device mounted in the first opening, the first mounting device including an outer portion abutting an outer surface of the first frame side wall and a first saddle extending inwards from an inner surface of the first frame side wall;
a second mounting device mounted in the second opening, the second mounting device including an outer portion abutting an outer surface of the second frame side wall and a second saddle extending inwards from an inner surface of the second frame side wall; and
a shaft having at least one conveyor component mounted thereon, the shaft including a first end rotatably mounted in the first saddle and a second end rotatably mounted in the second saddle.

16. The conveyor assembly of claim 15, wherein the first and second openings have a keyhole shape.

17. The assembly of claim 15, wherein each mounting device includes an inner portion forming a corresponding saddle, wherein the inner portion is smaller in width than the upper portion of the corresponding opening.

18. The assembly of claim 17, wherein each outer portion is greater in width than an upper portion of the corresponding opening.

19. The conveyor assembly of claim 15, wherein each mounting device includes a mounting channel formed between the inner portion and the outer portion for receiving a bottom edge of a corresponding opening.

20. The conveyor assembly of claim 15, wherein each mounting device includes a belt-protecting wing formed around each saddle.
